(19) United States
(12) Patent Application Publication
(10) Pub. No.: US 2007/0159051 A1
(43) Pub. Date: Jul. 12, 2007

(54) Flat fluorescent lamp and liquid crystal display apparatus having the same

(76) Inventors: Jin-Seob Byun, Seoul (KR); Don-Chan Cho, Seongnam-si (KR)

Correspondence Address: CANTOR COLBURN, LLP, 55 GRIFFIN ROAD SOUTH, BLOOMFIELD, CT, 06002, US

(21) Appl. No.: 11/485,718

(22) Filed: Jul. 13, 2006

(30) Foreign Application Priority Data
Jan. 11, 2006 (KR) 2006-3290

(51) Int. Cl. H01J 1/62; H01J 63/04

(52) U.S. Cl. 313/485; 313/484; 313/234

(57) ABSTRACT

A flat fluorescent lamp includes a first substrate, a second substrate, a first exhausting pipe and a second exhausting pipe. The second substrate is combined with the first substrate and forms a plurality of discharge spaces. The first exhausting pipe is disposed at a first longitudinal end portion of the discharge spaces between the first and second substrates such that the first exhausting pipe crosses the discharge spaces. The first exhausting pipe has first exhausting holes. The second exhausting pipe is disposed at a second longitudinal end portion of the discharge spaces between the first and second substrates such that the second exhausting pipe crosses the discharge spaces. The second exhausting pipe has second exhausting holes.

This application claims priority to Korean Patent Application No. 2006-3290 filed on Jan. 11, 2006, and all the benefits accruing therefrom under §119, the contents of which are herein incorporated by reference in its entirety.

### BACKGROUND OF THE INVENTION

1. Field of the Invention

The present invention relates to a flat fluorescent lamp and liquid crystal display apparatus having the flat fluorescent lamp. More particularly, the present invention relates to a flat fluorescent lamp capable of enhancing display quality by preventing floating of mercury of the lamp, and liquid crystal display apparatus having the flat fluorescent lamp.

2. Description of the Related Art

A liquid crystal display apparatus includes a liquid crystal display panel that is not self-emissive. Therefore, the liquid crystal display panel requires a light source that provides the liquid crystal display panel with light.

As a size of liquid crystal display apparatus increases, a demand for a flat fluorescent lamp increases. The flat fluorescent lamp includes a plurality of discharge spaces and electrodes crossing the discharge spaces. The flat fluorescent lamp provides the liquid crystal display panel with light having uniform luminance throughout large surface areas.

The discharge spaces of the flat fluorescent lamp are defined by a combination of an upper glass substrate and a lower glass substrate. The upper glass substrate includes discharge portions and non-discharge portions. Each of the non-discharge portions is disposed between the discharge portions.

The upper glass substrate and the lower glass substrate are combined with each other through a frit. The frit is disposed along edges of the upper glass substrate and the lower glass substrate. The non-discharge portions of the upper glass substrate are compressed by a pressure difference between inside and outside of the flat fluorescent lamp. Therefore, a minute gap may be formed between the upper glass substrate and the lower glass substrate in the non-discharge portions. Additionally, the flat fluorescent lamp includes a connection path connecting the discharge portions of the flat fluorescent lamp with each other in order to exhaust the gas disposed inside of the flat fluorescent lamp and inject discharge gas into the inside of the flat fluorescent lamp throughout the discharge spaces.

The flat fluorescent lamp generates heat when the flat fluorescent lamp is operated, so that discharge gas may circulate between the discharge portions through the minute gaps to induce a temperature difference between an upper portion and a lower portion of display screen of the liquid crystal display apparatus. As a result, mercury (Hg) included in the discharge gas, which is relatively heavy, is gathered at the lower portion to induce luminance difference between the upper portion and the lower portion. In other words, the upper portion becomes darker than the lower portion of the screen of the liquid crystal display apparatus.

### BRIEF SUMMARY OF THE INVENTION

An exemplary embodiment provides a flat fluorescent lamp preventing circulation of mercury, which is conventionally induced due to heat difference, to enhance display quality.

An exemplary embodiment also provides a liquid crystal display apparatus having the above flat fluorescent lamp.

An exemplary embodiment of flat fluorescent lamp includes a first substrate, a second substrate and a first exhausting pipe. The second substrate is combined with the first substrate and forms a plurality of discharge spaces. The first exhausting pipe is disposed at a first longitudinal end portion of the discharge spaces between the first and second substrates such that the first exhausting pipe crosses the discharge spaces.

In an exemplary embodiment, the exhausting pipe includes first exhausting holes through which air of the discharge space is exhausted and discharge gas is injected into the discharge space.

In an exemplary embodiment, the flat fluorescent lamp may further include a second exhausting pipe disposed at a second longitudinal end portion of the discharge spaces between the first and second substrates such that the second exhausting pipe crosses the discharge spaces. The second exhausting pipe includes second exhausting holes through which air of the discharge space is exhausted and discharge gas is injected into the discharge space.

In an exemplary embodiment, the first exhausting holes correspond to odd-numbered discharge spaces, respectively, and the second exhausting holes correspond to even-numbered discharge spaces, respectively.

In an exemplary embodiment, the first exhausting holes correspond to each of the discharge spaces, respectively, and the second exhausting holes correspond to each of the discharge spaces, respectively.

An exemplary embodiment of a liquid crystal display apparatus includes a flat fluorescent lamp, a receiving container and a liquid crystal display panel. The flat fluorescent lamp generates light. The receiving container receives the flat fluorescent lamp. The liquid crystal display panel displays images using the light generated by the flat fluorescent lamp. The flat fluorescent lamp includes a first substrate, a second substrate, a first exhausting pipe and a second exhausting pipe. The second substrate is combined with the first substrate and forms a plurality of discharge spaces. The first exhausting pipe is disposed at a first longitudinal end portion of the discharge spaces and between the first and second substrates such that the first exhausting pipe crosses the discharge spaces. The first exhausting pipe has first exhausting holes. The second exhausting pipe is disposed at a second longitudinal end portion of the discharge spaces and between the first and second substrates such that the second exhausting pipe crosses the discharge spaces. The second exhausting pipe has second exhausting holes.

In an exemplary embodiment, each of the discharge spaces may be completely sealed to prevent mercury from moving between the discharge spaces. Therefore, the dark region is reduced.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a perspective view illustrating an exemplary embodiment of a flat fluorescent lamp according to the present invention;

FIG. 2 is an exploded perspective view illustrating the flat fluorescent lamp in FIG. 1;

FIG. 3 is a cross-sectional view taken along line I-I′ in FIG. 1;

FIG. 4 is a cross-sectional view taken along line II-II′ in FIG. 1;

FIG. 5 is a perspective view illustrating an exemplary embodiment of a first exhausting pipe in FIG. 2;

FIG. 6 is a plan view illustrating an exemplary embodiment of a position of first and second exhausting pipe in FIG. 2;

FIG. 7 is a plan view illustrating another exemplary embodiment of a position of the first and second exhausting pipe;

FIG. 8 is a plan view illustrating another exemplary embodiment of a position of the first and second exhausting pipe; and

FIG. 9 is an exploded perspective view illustrating an exemplary embodiment of a liquid crystal display apparatus according to the present invention.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “lower” relative to other elements or features would then be oriented “upper” the other elements or features. Thus, the term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

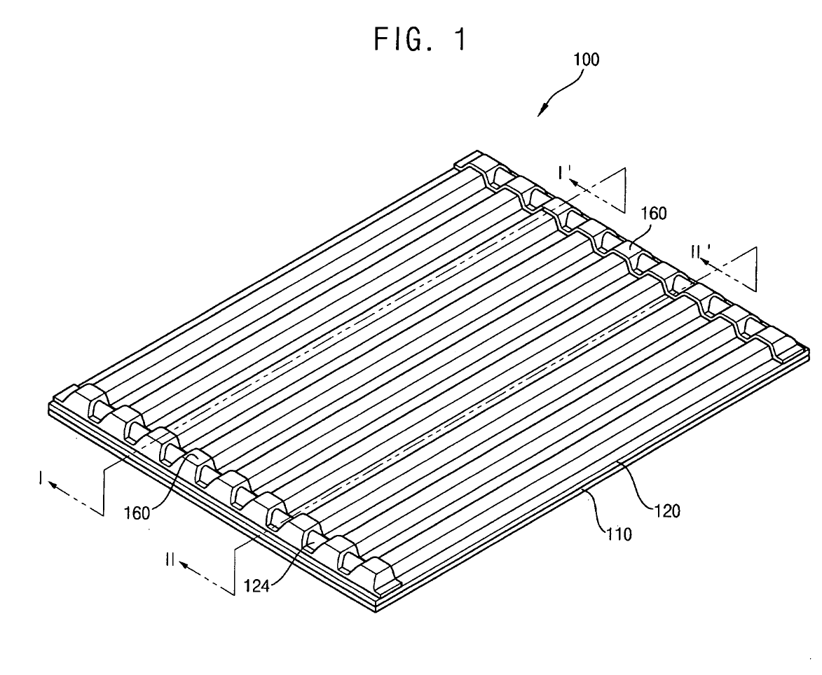

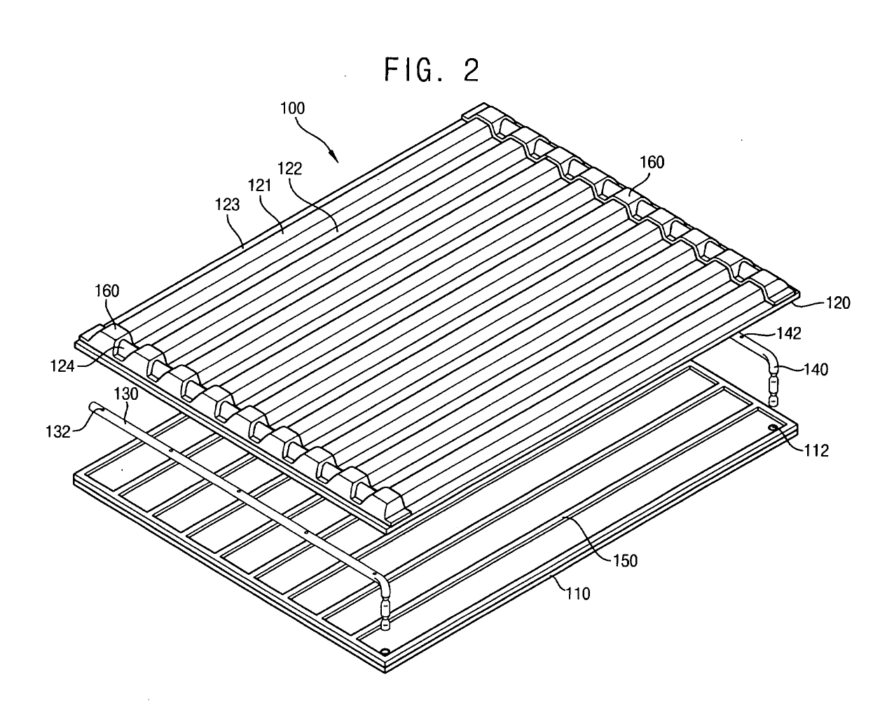

FIG. 1 is a perspective view illustrating an exemplary embodiment of a flat fluorescent lamp according to the present invention, and FIG. 2 is an exploded perspective view illustrating the flat fluorescent lamp in FIG. 1.

Referring to FIGS. 1 and 2, a flat fluorescent lamp 100 includes a first substrate 110, a second substrate 120, a first exhausting pipe 130 and a second exhausting pipe 140. The first and second substrates 110 and 120 are combined with each other. The first and second exhausting pipes 130 and 140 are disposed between the first and second substrates 110 and 120.

The flat fluorescent lamp 100 includes a plurality of discharge spaces generating light. The discharge spaces are spaced apart from each other. The flat fluorescent lamp 100 has a substantially rectangular shape when viewed on a plan.

The flat fluorescent lamp 100 generates plasma discharge in the discharge spaces by electric power provided by an inverter (not shown). Ultraviolet light generated by the plasma discharge is converted into a visible light. The flat fluorescent lamp has a relatively broad light emitting area. In order to enhance light emitting efficiency, an internal space of the flat fluorescent lamp is divided into the discharge spaces.

The first substrate 110 has substantially a rectangular plate shape. The first substrate 110 may include, but is not limited to, sodalime glass. The first substrate 110 may further include material for blocking ultraviolet light in order to prevent leakage of ultraviolet light.

The second substrate 120 is combined with the first substrate 110 to form the plurality of discharge spaces. The second substrate 120 may include, for example, sodalime glass. The second substrate 120 may further include material for blocking ultraviolet light in order to prevent leakage of ultraviolet light.

The second substrate 120 is formed to have the discharge spaces, such as through a forming process. In exemplary embodiments, a sodalime glass having a flat plate shape is heated to a temperature higher than softening point. The heated sodalime glass is compressed or blown to have a plurality of furrows corresponding to the discharge spaces. The softening point is a temperature at which glass has fluidity. In an exemplary embodiment, the sodalime glass has a softening point of about 727° C.

In exemplary embodiments, the second substrate 120 may be formed through other processes. In an exemplary embodiment, the second substrate 120 may be formed through a mold or a metallic pattern.

The first and second exhausting pipes 130 and 140 are disposed between the first and second substrates 110 and 120. The first and second exhausting pipes 130 and 140 are disposed at first and second longitudinal end portions of the discharge spaces such that the first and second exhausting pipes 130 and 140 cross the discharge spaces in a direction substantially transverse to the longitudinal direction of the first and second substrates 110 and 120.

The first exhausting pipe 130 has a first exhausting hole 132 through which gas of the discharge space is exhausted and/or discharge gas is injected into the discharge spaces. The second exhausting pipe 140 has a second exhausting hole 142 through which gas of the discharge space is exhausted and/or discharge gas is injected into the discharge spaces. The discharge gas injected into the discharge spaces may include, but is not limited to, mercury (Hg), neon (Ne) and argon (Ar).

First ends of the first and second exhausting pipes 130 and 140 are bent to be drawn out of the first substrate 110. In order for the first ends of the first and second exhausting pipes 130 and 140 to be drawn out of the first substrate 110, the first substrate 110 has an exhausting pipe hole 112 through which the first ends of the first and second exhausting pipes 130 and 140, which are bent, are drawn out.

In order to form the discharge spaces, the second substrate 120 includes discharge portions 121, non-discharge portions 122 and a sealing portion 123. The discharge portions 121 of the second substrate 120 are spaced apart from the first substrate 110 to form the discharge spaces. Each of the non-discharge spaces is disposed between the discharge portions 121 in a direction substantially transverse to the second substrate 120. The non-discharge portions 122 make contact with the first substrate 110 to define the discharge spaces. The sealing portion 123 corresponds to edge portions of the second substrate 120. The sealing portion 123 of the second substrate 120 makes contact with the first substrate 110 to combine the first and second substrates 110 and 120.

When the first and second substrates 110 and 120 are combined with each other, the discharge spaces are formed by the discharge portions 121 separated from the first substrate 110. In an exemplary embodiment, each of the discharge portions 121 has a width of about 10 mm and each of the non-discharge portions 122 has a width of about 4 mm. The width is defined as a length of the discharge and non-discharge portions 121 and 122 taken substantially parallel to the first and second substrates 110 and 120 in a transverse direction.

The second substrate 120 further includes a receiving portion 124 for receiving the first and second exhausting pipes 130 and 140. The receiving portion 124 is formed at a longitudinal end portion of the discharge spaces substantially in a transverse direction of the second substrate 120.

The flat fluorescent lamp 100 further includes an adhesive 150 combining the first and second substrates 110 and 120. In exemplary embodiments, frit having a lower melting temperature than that of pure glass may be employed as the adhesive 150. Frit corresponds to a mixture of glass and metal.

The adhesive 150 is disposed at the sealing portion 123 and the non-discharging portion 122 to combine the first and second substrates 110 and 120 and effectively completely seal the discharge spaces from each other.

In exemplary embodiments, the adhesive 150 between the first and second substrates 110 and 120 is heated to be melted and combines the first and second substrates 110 and 120. In an exemplary embodiment, a process of combining the first and second substrates 110 and 120 is performed at a temperature of about 400° C. to about 600° C.

The flat fluorescent lamp 100 may further include an external electrode 160 applying electric power to the discharge gas of the discharge spaces. The external electrode 160 may be formed on at least one surface of the first and/or second substrates 110 and 120. The external electrode 160 is formed at a longitudinal end portion of the discharge spaces such that the external electrode 160 crosses the discharge spaces in a transverse direction of the first and second substrates 110 and 120.

In exemplary embodiments, when the external electrodes 160 are formed at a surface of both the first and second substrates 110 and 120, the first electrodes 160 of the first and second substrates 110 and 120 are electrically connected to each other through a connecting member such as a clip (not shown).

The external electrode 160 may include conducting material for receiving the discharge voltage from the inverter (not shown). The external electrode 160 may include metal or metal alloy. In exemplary embodiments, the external electrode 160 may include, but is not limited to, a silver paste including silver (Ag) and silicon oxide (SiO2). The external electrode 160 may be formed by any of a number of suitable processing methods, such as through a spray method, a spin coating method, a dipping method, etc. Additionally, the external electrode 160 may be formed through a metal socket.

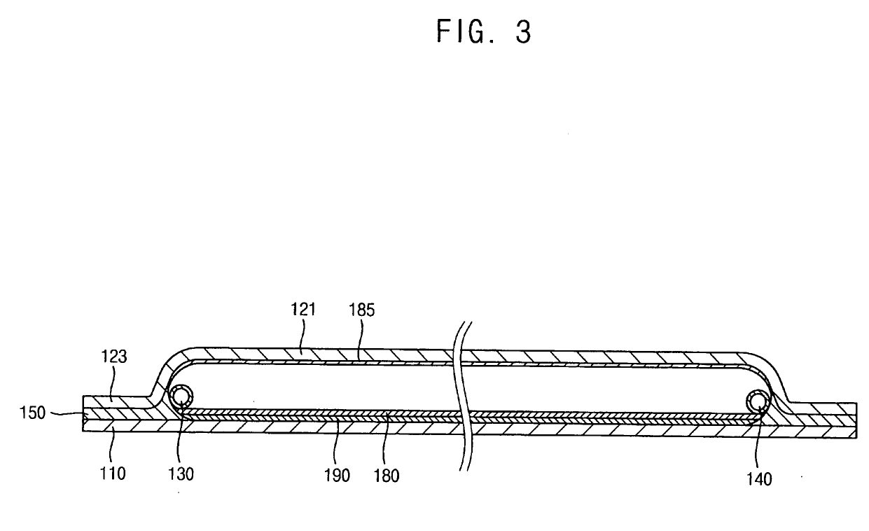

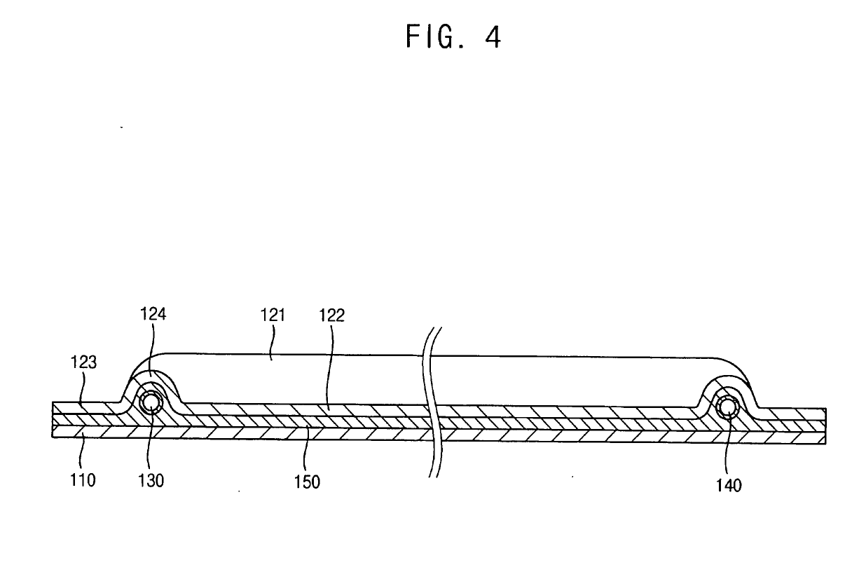

FIG. 3 is a cross-sectional view taken along line I-I′ in FIG. 1, and FIG. 4 is a cross-sectional view taken along line II-II′ in FIG. 1.

Referring to FIGS. 3 and 4, the first and second exhausting pipes 130 and 140 are disposed between the first and second substrates 110 and 120. The first and second exhausting pipes 130 and 140 are disposed at first and second longitudinal end portions of the discharge spaces 170, respectively.

In exemplary embodiments, the first and second exhausting pipes 130 and 140 are fastened, to the second substrate 120 through the adhesive 150.

The first and second exhausting pipes 130 and 140 are disposed in the receiving portion 124, and stably fastened to the second substrate 120.

The non-discharging portions 122 and the sealing portion 123 of the second substrate 120 are combined with the first substrate 110 through the adhesive 150. Therefore, the discharge spaces 170 formed by the discharge portions 121 of the second substrate 120 are completely sealed from each other. As a result, transferring of mercury or discharge gas between the discharge spaces 170, which is conventionally induced by heat difference, is effectively prevented.

The flat fluorescent lamp 100 may further include a first fluorescent layer 180 and/or a second fluorescent layer 185. The first fluorescent layer 180 may be formed on a surface of the first substrate 110 that faces the second substrate 120. The second fluorescent layer 185 may be formed on a surface of the second substrate 120 that faces the first substrate 110. The first and second fluorescent layers 180 and 185 convert ultraviolet light generated from the discharge gas into visible light.

The flat fluorescent layer 100 may further include a reflecting layer 190 disposed between the first substrate 110 and the first fluorescent layer 180. The reflecting layer 190 reflects visible light converted by the first fluorescent layer 100 toward the second substrate 120. As a result, a leakage of the visible light is reduced or effectively prevented.

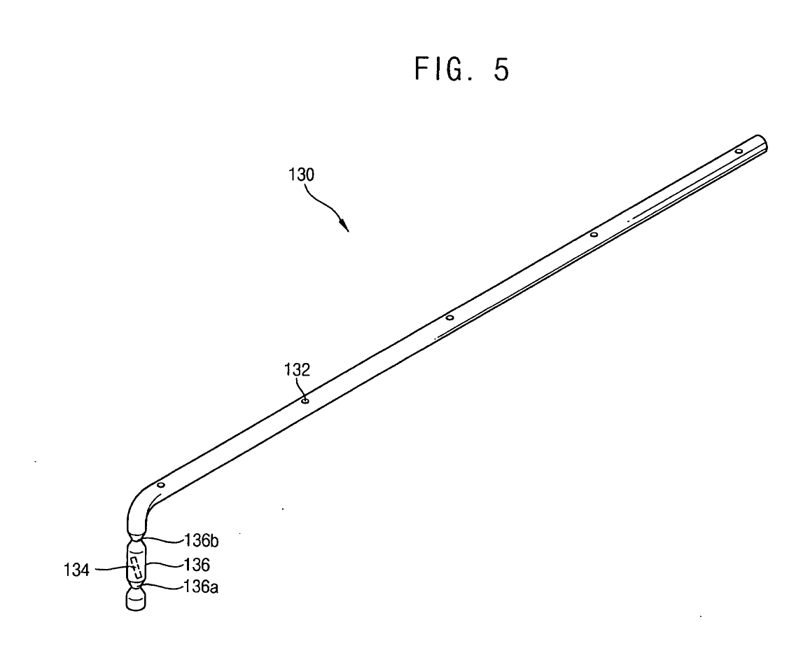

FIG. 5 is a perspective view illustrating an exemplary embodiment of a first exhausting pipe in FIG. 2.

Referring to FIGS. 2 and 5, the first exhausting pipe 130 has a substantially cylindrical pipe shape for exhausting air from the discharge spaces 170 and injecting discharging gas into the discharge spaces 170. In an exemplary embodiment, the first exhausting pipe 130 has a diameter of about 1.0 millimeter (mm) to about 1.5 millimeters (mm).

The first exhausting pipe 130 has the first exhausting hole 132 through which air of the discharge gas is exhausted and/or discharge gas is injected into the discharge space. In an exemplary embodiment, the first exhausting hole 132 has a diameter of about 10 micrometers (μm) to about 100 micrometers (μm).

The exhausting hole 132 is correspondingly formed to the discharge spaces 170. In exemplary embodiments, one exhausting hole 132 corresponds to one discharge space 170. In alternative exemplary embodiments, more than one exhausting hole 132 may correspond to one discharge space 170.

A first end portion of the exhausting pipe 130 is bent to be extracted out of the first substrate 110. The first exhausting pipe 130 further includes a getter-receiving portion 136 for receiving a getter 134. The getter-receiving portion 136 is formed at the first end portion of the first exhausting pipe 130 and is disposed at an outside of the flat fluorescent lamp 100 when the first and second substrates 110 and 120 are combined with each other. The getter 134 includes mercury (Hg), which is one element of the discharge gas. First and second end portions 136a and 136b of the getter-receiving portion 136 has a narrower diameter than that of the first exhausting pipe 130 and/or the getter 134 in order to prevent moving of the getter 134.

The second exhausting pipe 140 has a substantially same shape as that of the first exhausting pipe 130. Therefore, any further explanation about the second exhausting pipe 140 will be omitted.

Hereinafter, an exemplary embodiment of assembling of the flat fluorescent lamp 100 will be explained. The first and second exhausting pipes 130 and 140 are attached to the second substrate 120 (having the discharge portion, the non-discharge portion and the sealing portion) through an attachment member, such as frit. The first substrate 110 is combined with the second substrate 120 through the adhesive 150 such that the getter-receiving portions 136 of the first and second exhausting pipes 130 and 140 are disposed outside of the first substrate 110. In exemplary embodiments, the above procedure may be performed at a temperature of about 400° C. to about 600° C., such that the adhesive and/or frit is melted.

Air in the discharge spaces is exhausted through the first and second exhausting pipes 130 and 140 to form the discharge space 170 to be substantially in a vacuum state.

Discharge gas including, but not limited to, neon (Ne), argon (Ar), xenon (Xe), krypton (Kr), etc. is injected into the discharge space 170 via the first and second exhausting pipes 130 and 140.

The first end portion 136a of the getter-receiving portion 136 is sealed, such as by cutting.

Electromagnetic wave of high frequency is applied to the getter 134 in the getter-receiving portion 136 to generate mercury gas. The mercury gas is injected into the discharge spaces through the first and second exhausting pipes 130 and 140.

Te second end portion 136b of the getter-receiving portion 136 is sealed, such as by cutting.

In exemplary embodiments, when the flat fluorescent lamp 100 is completed, the discharge space 170 has about 30 torr pressure due to the discharge gas.

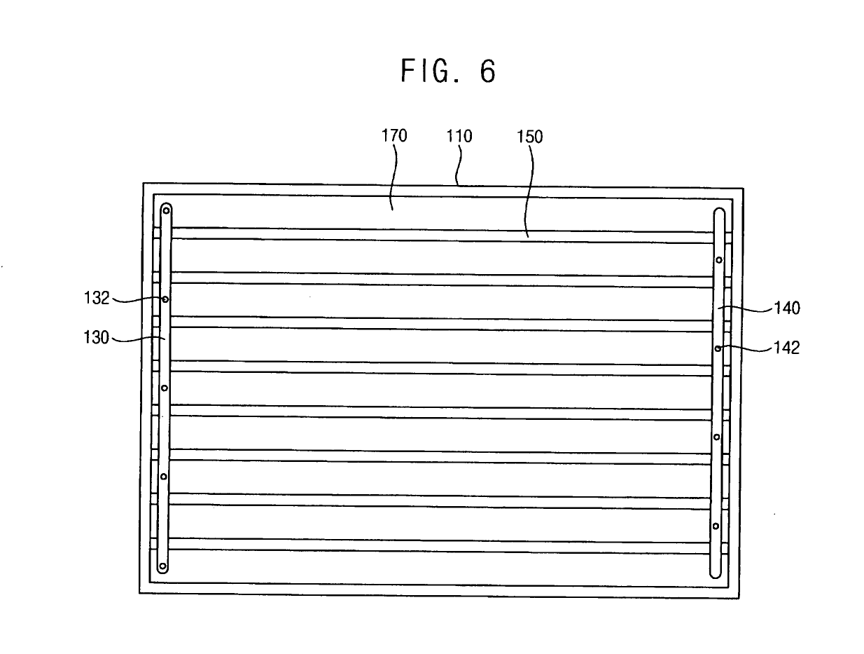

FIG. 6 is a plan view illustrating an exemplary embodiment of a position of first and second exhausting pipes in FIG. 2.

Referring to FIG. 6, the first and second exhausting pipes 130 and 140 are disposed at first and second longitudinal end portions of the discharge spaces 170 such that the first and second exhausting pipes 130 and 140 cross the discharge spaces 170.

The first exhausting pipe 130 has first exhausting holes 132 through which air of the discharge spaces is exhausted and/or discharge gas is injected into the discharge space. The second exhausting pipe 140 has second exhausting holes 142 through which air of the discharge spaces 170 is exhausted and/or discharge gas is injected into the discharge space 170.

In the illustrated embodiment of FIG. 6, the first exhausting holes 132 may correspond to what are considered odd-numbered discharge spaces 170, and the second exhausting holes 142 correspond to what are considered even-numbered discharge spaces 170.

When the first and second exhausting holes 132 and 142 form a zigzag shape (such as if the first and second exhausting holes 132 and 142 were connected by a line), a channel effect that may occur when driving of the flat fluorescent lamp 100 is performed at a low temperature is reduced. That is, the first and second exhausting holes 132 and 142 arranged corresponding to alternating discharge spaces 170 reduces the channel effect.

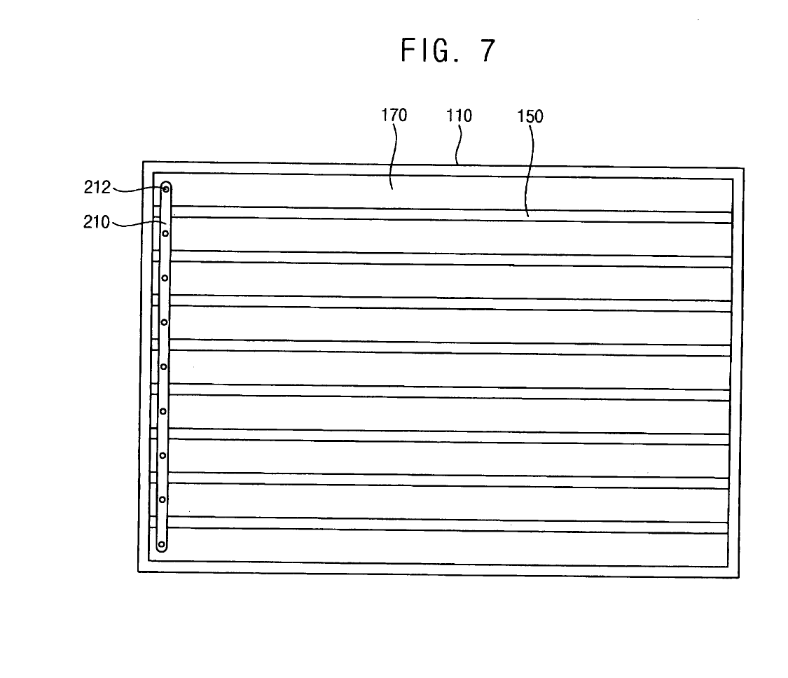

FIG. 7 is a plan view illustrating another exemplary embodiment of a position of first and second exhausting pipe.

Referring to FIG. 7, a flat fluorescent lamp includes only one exhausting pipe 210. The exhausting pipe 210 is disposed at first longitudinal end portion of the discharge spaces 170 such that the exhausting pipe 210 crosses the discharge spaces 170 in a substantially transverse direction of the discharge spaces 170.

The exhausting pipe 210 includes exhausting holes 212. The exhausting holes 212 correspond in location to the discharge spaces 170, respectively.

When the flat fluorescent lamp 100 includes only one exhausting pipe 210 having exhausting holes 212 corresponding to each of the discharge spaces 170, respectively, an assemblage process is enhanced.

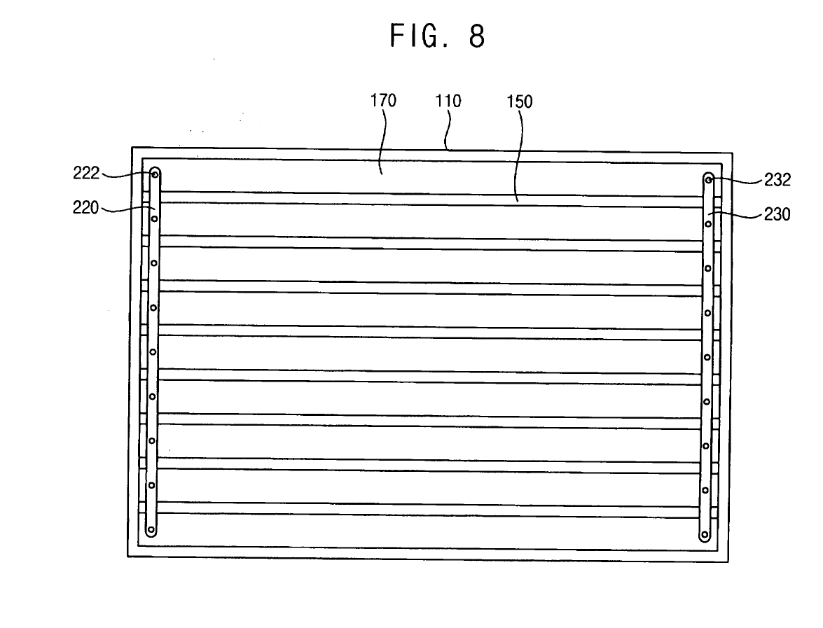

FIG. 8 is a plan view illustrating another exemplary embodiment of a position of first and second exhausting pipes.

Referring to FIG. 8, a flat fluorescent lamp includes a first exhausting pipe 220 and a second exhausting pipe 230. The first and second exhausting pipes 220 and 230 are disposed at first and second longitudinal end portions of the discharge spaces 170, such that the first and second exhausting pipes 220 and 230 cross the discharge spaces 170.

The first exhausting pipe 220 has first exhausting holes 222 through which air of the discharge spaces is exhausted and discharge gas is injected into the discharge space. The second exhausting pipe 230 has second exhausting holes 232 through which air of the discharge spaces is exhausted and discharge gas is injected into the discharge space.

The first exhausting holes 222 correspond to the discharge spaces 170, respectively. Additionally, the second exhausting holes 232 correspond to the discharge spaces 170, respectively. In the illustrated exemplary embodiment of FIG. 8, each of the discharge spaces 170 has two exhausting holes. In alternative exemplary embodiments, a portion of the discharge spaces 170 may correspond to more than one exhausting hole and the remainder of the discharge spaces 170 may correspond to a single exhausting hole as is suitable for the purposes described herein.

When both the first and second exhausting hole 222 and 232 of the first and second exhausting pipes 220 and 230 correspond to an individual discharge spaces, a time for exhausting air of the discharge spaces 170 and injecting discharge gas into the discharge space may be reduced to enhance productivity.

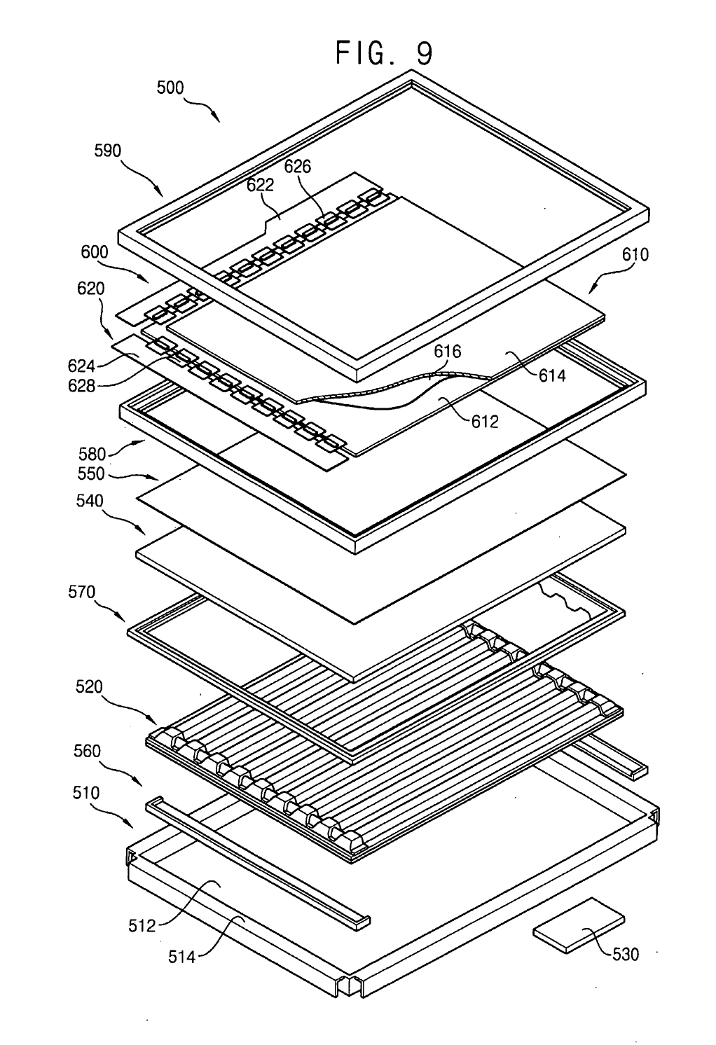

FIG. 9 is an exploded perspective view illustrating an exemplary embodiment of a liquid crystal display apparatus according to the present invention.

Referring to FIG. 9, a liquid crystal display apparatus 500 includes a receiving container 510, a flat fluorescent lamp 520 and a display unit 600.

The receiving container 510 includes a bottom portion 512 supporting the flat fluorescent lamp 520 and sidewall portion 514 extended from edge of the bottom portion 512 to define a receiving space. The sidewall portion 514 includes a first sidewall part extended from the edge of the bottom portion 512, a second sidewall part extended substantially horizontally from an edge of the first sidewall part and a third sidewall part extended substantially vertically toward the bottom portion 512. The sidewall portion 514 has a double-bent structure formed by the second sidewall part and the third sidewall part. In exemplary embodiments, the receiving container 510 may include, but is not limited to, metal with high strength and low deformation.

The flat fluorescent lamp 520 is received by the receiving container 510 and generates light when discharge voltage is applied thereto from the inverter 530. The flat fluorescent lamp 520 may be one of the illustrated embodiments above with respect to FIGS. 1 to 8. Thus, any further explanation will be omitted.

The display unit 600 includes a liquid crystal display panel 610 and a driving circuit 620. The liquid crystal display panel 610 displays images by using light provided by the flat fluorescent lamp 520. The driving circuit 620 drives the liquid crystal display panel 610.

The liquid crystal display panel 610 includes a lower substrate 612, an upper substrate 614 facing the lower substrate 612, and a liquid crystal layer 616 disposed between the lower substrate 612 and the upper substrate 614.

The lower substrate 612 may include a plurality of thin film transistors (TFTs) arranged in a matrix shape. Each of the TFTs includes a gate electrode electrically connected to one of the gate lines, a source electrode electrically connected to one of the data lines and a drain electrode electrically connected to the pixel electrode. The pixel electrode includes an optically transparent and electrically conductive material.

The upper substrate 614 may include color filters and a common electrode. In exemplary embodiments, the color filters include a red color filter, a green color filter and a blue color filter. The common electrode may include an optically transparent and/or electrically conductive material.

When a gate voltage is applied to the gate electrode of the TFT to turn on the TFT, electric fields are generated between the pixel electrode of the lower substrate 612 and a common electrode of the upper substrate 614. When electric fields are generated between the pixel electrode and the common electrode, an arrangement of liquid crystal molecules of the liquid crystal layer 616 is changed to alter transmittance. Therefore, images are displayed.

The driving circuit 620 includes a data printed circuit board 622, a gate printed circuit board 624, a data driving circuit film 626 and a gate driving circuit film 628. The data printed circuit board 622 provides the liquid crystal display panel 610 with a data-driving signal. The gate printed circuit board 624 provides the liquid crystal display panel 610 with a gate-driving signal. The data driving circuit film 626 electrically connects the data printed circuit board 622 to the liquid crystal display panel 610. The gate driving circuit film 628 electrically connects the gate printed circuit board 624 to the liquid crystal display panel 610.

The data driving circuit film 626 and the gate driving circuit film 628 may include a configuration of a tape carrier package (TCP) or chip on film (COF). In exemplary embodiments, when additional wirings are formed on the liquid crystal display panel 610 and the gate driving circuit film 628, the display unit 600 does not require the gate printed circuit board 624.

The liquid crystal display apparatus 500 further includes the inverter 530 providing the flat fluorescent lamp 520 with electric power. In exemplary embodiments, the inverter 530 is disposed on the backside face of the receiving container 510. The inverter 530 boosts up an alternating current of a low level to an alternating current of high level, so that the discharge voltage for the flat fluorescent lamp 520 is generated. The discharge voltage is applied to the external electrode of the flat fluorescent lamp 520.

The liquid crystal display apparatus 500 may further include a diffusing plate 540 disposed on the flat fluorescent lamp 520 and at least one optical sheet 550 disposed on the diffusing plate 540.

The diffusing plate 540 diffuses light generated by the flat fluorescent lamp 520 to enhance luminance uniformity. The diffusing plate 540 has a substantially plate shape having a predetermined thickness. In exemplary embodiments, the diffusing plate 540 is disposed such that the diffusing plate 540 is spaced apart from the flat fluorescent lamp 520.

The diffusing plate 540 includes an optically transparent material and diffusing member for diffusing light. In exemplary embodiments, the diffusing plate 540 includes polymethylmethacrylate (PMMA).

The optical sheet 550 adjusts light path to enhance optical properties of light. In exemplary embodiments, the optical sheet 550 may include a prism sheet for condensing light to enhance front-view luminance.

In exemplary embodiments, the optical sheet 550 may include a diffusing sheet for diffusing light to enhance luminance uniformity.

In exemplary embodiments, the optical sheet 550 may include a reflective polarizing sheet that transmits a portion of light and reflects a remaining portion of the light. In alternative exemplary embodiments, the optical sheet 550 may include all of the above-mentioned sheets. The optical sheet 550 may also include or exclude other optical sheets for required optical characteristics.

The liquid crystal display apparatus 500 may further include a buffering member 560 disposed between the flat fluorescent lamp 520 and the receiving container 510.

The buffering member 560 is placed at the edge portion of the flat fluorescent lamp 520 from the receiving container 510 to prevent contact between the flat fluorescent lamp 520 and the receiving container 510.

In exemplary embodiments, the buffering member 560 includes an elastic material in order to absorb the impact applied from the outside and to buffer contact between the flat fluorescent lamp 520 and the receiving container 510. The buffering member 560 may include silicone.

The liquid crystal display apparatus 500 may further include a first mold 570 disposed between the flat fluorescent lamp 520 and the diffusing plate 540.

The first mold 570 fixes edge portions of the flat fluorescent lamp 520 and supports edge portions of the diffusing plate 540. The first mold 570 covers the external electrode of the flat fluorescent lamp 520, which emits no light, to prevent the dark region.

The first mold 570 may have a substantially frame shape. In alternative exemplary embodiments, the first mold 570 may include two U-shaped pieces. In alternative exemplary embodiments, the first mold 570 may include four L-shaped pieces disposed at four corners, respectively.

The liquid crystal display apparatus 500 may further include a second mold 580 disposed on the first mold 570 to fix edge portions of the diffusing plate 540 and the optical sheet 550.

As in the first mold 570, the second mold 580 may have a substantially frame shape. In alternative exemplary embodiments, the second mold 580 includes two U-shaped pieces. In alternative exemplary embodiments, the second mold 580 may include four L-shaped pieces disposed at four corners, respectively.

The liquid crystal display apparatus 500 may further include a top chassis 590 for fixing the display unit 600. The top chassis 590 is combined with the receiving container 510 to fasten the liquid crystal display panel 610 to the receiving container 510. When the top chassis 590 is combined with the receiving container 510, the data driving circuit film 626 is bent, so that data printed circuit board 622 is disposed on a backside of the receiving container 510. In exemplary embodiments, the top chassis 590 includes metal having high strength and low deformity.

In the illustrated exemplary embodiments, of the flat fluorescent lamp and liquid crystal display apparatus having the flat fluorescent lamp, each of the discharge spaces are completely sealed to prevent mercury from moving between the discharge spaces. Advantageously, the dark region is reduced.

Additionally, the first and second exhausting pipes are disposed at the first and second longitudinal end portions of the discharge spaces such that the first exhausting holes of the first exhausting pipe and the second exhausting holes of the second exhausting pipe are arranged in a zigzag shape to prevent channeling even when the flat fluorescent lamp is driven at a low temperature.

Having described the example embodiments of the present invention and its advantages, it is noted that various changes, substitutions and alterations can be made herein without departing from the spirit and scope of the invention as defined by appended claims.

What is claimed is:

1. A flat fluorescent lamp comprising:
a first substrate;
a second substrate combined with the first substrate and forming a plurality of discharge spaces; and
a first exhausting pipe disposed at a first longitudinal end portion of the discharge spaces between the first and second substrates such that the first exhausting pipe crosses the discharge spaces.

2. The flat fluorescent lamp of claim 1, wherein the exhausting pipe comprises first exhausting holes through which air of the discharge space is exhausted and discharge gas is injected into the discharge space.

3. The flat fluorescent lamp of claim 2, further comprising a second exhausting pipe disposed at a second longitudinal end portion of the discharge spaces between the first and second substrates such that the second exhausting pipe crosses the discharge spaces.

4. The flat fluorescent lamp of claim 3, wherein the second exhausting pipe comprises second exhausting holes through which air of the discharge space is exhausted and discharge gas is injected into the discharge space.

5. The flat fluorescent lamp of claim 4, wherein the first exhausting holes correspond to odd-numbered discharge spaces, respectively, and the second exhausting holes correspond to even-numbered discharge spaces, respectively.

6. The flat fluorescent lamp of claim 4, wherein each of the discharge spaces corresponds to one of the first exhausting holes or the second exhausting holes.

7. The flat fluorescent lamp of claim 4, wherein the first exhausting holes correspond to each of the discharge spaces, respectively, and the second exhausting holes correspond to each of the discharge spaces, respectively.

8. The flat fluorescent lamp of claim 2, wherein each of the first exhausting holes has a diameter of about 10 micrometers (μm) to about 100 micrometers (μm).

9. The flat fluorescent lamp of claim 2, wherein the first exhausting pipe has a cylindrical pipe shape.

10. The flat fluorescent lamp of claim 9, wherein the first exhausting pipe has a diameter of about 1.0 millimeter (mm) to about 1.5 millimeters (mm).

11. The flat fluorescent lamp of claim 1, wherein the second substrate comprises:
a plurality of discharge portions spaced apart from the first substrate and forming the discharge spaces;
a plurality of non-discharge portions contacting the first substrate, each of the non-discharge portions being disposed between the discharge portions;
a receiving portion formed at the non-discharge portions and receiving the first exhausting pipe; and
a sealing portion corresponding to edge portions of the second substrate, the sealing portion contacting the first substrate.

12. The flat fluorescent lamp of claim 11, further comprising an adhesive combining the sealing portion and the non-discharge portion to the first substrate and sealing individual discharge spaces from each other.

13. The flat fluorescent lamp of claim 12, wherein the adhesive comprises frit.

14. The flat fluorescent lamp of claim 1, wherein the first substrate comprises an exhausting pipe hole and a first end portion of the first exhausting pipe passes through the exhausting pipe hole.

15. The flat fluorescent lamp of claim 14, wherein the first end portion of the first exhausting pipe comprises a getter-receiving portion receiving a getter.

16. The flat fluorescent lamp of claim 1, further comprising:
a first fluorescent layer formed on a first surface of the first substrate, the first surface of the first substrate facing the second substrate;
a second fluorescent layer formed on a first surface of the second substrate, the first surface of the second substrate facing the first substrate; and
a reflecting layer formed between the first fluorescent layer and the first substrate.

17. A liquid crystal display apparatus comprising:
a flat fluorescent lamp generating light;
a receiving container receiving the flat fluorescent lamp; and
a liquid crystal display panel displaying images using the light generated of the flat fluorescent lamp, wherein the flat fluorescent lamp comprises;
a first substrate;
a second substrate combined with the first substrate and forming a plurality of discharge spaces;
a first exhausting pipe disposed at a first longitudinal end portion of the discharge spaces and between the first and second substrates such that the first exhausting pipe crosses the discharge spaces, the first exhausting pipe comprising first exhausting holes; and
a second exhausting pipe disposed at a second longitudinal end portion of the discharge spaces and between the first and second substrates such that the second exhausting pipe crosses the discharge spaces, the second exhausting pipe comprising second exhausting holes.

18. The liquid crystal display apparatus of claim 17, wherein the first exhausting holes correspond to odd-numbered discharge spaces, respectively, and the second exhausting holes correspond to even-numbered discharge spaces, respectively.

19. The liquid crystal display of claim 18, wherein the first and second exhausting pipes have a cylindrical pipe shape having a diameter of about 1.0 mm to about 1.5 mm, and
the first and second exhausting holes have a diameter of about 10 μm to about 100 μm.

20. The liquid crystal display of claim 18, wherein the second substrate comprises:
a plurality of discharge portions spaced apart from the first substrate and forming the discharge spaces;
a plurality of non-discharge portions contacting the first substrate, each of the non-discharge portions being disposed between the discharge portions;
a receiving portion formed at the non-discharge portions and receiving the first exhausting pipe; and
a sealing portion corresponding to edge portions of the second substrate, the sealing portion contacting the first substrate.

21. The liquid crystal display of claim 20, further comprising an adhesive combining the sealing portion and the non-discharge portion to the first substrate.

22. A method of forming a flat fluorescent lamp, the method comprising:
combining a first substrate and a second substrate to form a plurality of discharge spaces, the second substrate comprising receiving portions at longitudinal ends of the discharge spaces; and
disposing a first exhausting pipe and a second exhausting pipe in the receiving portions, in a transverse direction of the discharge spaces and between the first and the second substrates;
wherein each of the first exhausting pipe and the second exhausting pipe comprises a plurality of exhausting holes corresponding to the plurality of discharge spaces.
